(19) United States
(12) Patent Application Publication
(10) Pub. No.: US 2008/0195698 A1
(43) Pub. Date: Aug. 14, 2008

(54) Method and System for Transforming and Delivering Video File Content for Mobile Devices

(75) Inventors: Nemanja Stefanovic, Elk Grove Village, IL (US); William Frederick Dyer, Cary, IL (US); Ketan B. Patel, Naperville, IL (US); Thomas Eric Hayosh, Lake Zurich, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NOVARRA, INC., Itasca, IL (US)

(21) Appl. No.: 11/869,832

(22) Filed: Oct. 10, 2007

Related U.S. Application Data
(60) Provisional application No. 60/889,140, filed on Feb. 9, 2007.

(51) Int. Cl. G06F 15/16

(52) U.S. Cl. 709/203

(57) ABSTRACT

A method and system for accessing video file content is provided. When a user encounters a webpage with video content, the user can select to view the video content and wait for the server to transcode the video file and to stream the transcoded video file to the user's client device. Alternatively, the user may request that the server transcode the video file and to send the transcoded video file to the user's device, where the transcoded video file will be stored. While waiting for the video to be transcoded, the user may browse other websites, for example. The user may then view the video file at a later time that is convenient by accessing a video file inbox. The transcoded video file could alternatively be stored at the server, which can send a notification to the user's device to indicate that the video file has been transcoded.

### CROSS REFERENCE TO RELATED APPLICATION

The present patent application claims priority under 35 U.S.C. § 119(e) to U.S. Provisional Patent Application Ser. No. 60/889,140, filed on Feb. 9, 2007, the entire contents of which are incorporated herein by reference as if fully set forth in this description.

### FIELD OF INVENTION

The present application relates generally to the field of web browsing and network communications. More specifically, the application relates to a system and method for adapting and presenting information from web pages containing content designed for large screen computers to display on a handheld device, such as a cellular telephone or personal digital assistance (PDA).

### BACKGROUND

Today, many worldwide web pages (HTML documents) are available that offer a variety of textual and non-textual content types. As known, a Web page is conventionally formatted via a standard page description language such as HyperText Markup Language (HTML), which typically contains text and can reference graphics, sound, animation, and video data. HTML provides for basic document formatting and allows a Web content provider to specify anchors or hypertext links to other Web servers and files. When a user selects a particular hypertext link, a Web browser reads and interprets an address, called a Uniform Resource Locator (URL) associated with the link, connects with a Web server at that address, and initiates an HTTP request for the file identified in the link. The Web server then sends the requested file to the Web browser to interpret and display the file to the user.

On a traditional desktop or laptop computer with a large screen running a standard web browser, HTML content types are easily arranged and displayed for viewing. For example, web sites for searching realtor property listings often deliver a plurality of images for the viewer to quickly scan for a property of interest. When the user identifies a property of interest, they can then read the details associated with the image of that specific property and select that image for further details about the property.

At the same time, the field of communications, and more specifically wireless telecommunications, is currently undergoing a radical expansion. This technological expansion allows an electronic device, such as mobile personal digital assistant (PDA), cellular phone, pager, and other electronic devices to connect to the same information sources, such as a web server or database, as one could with the PC and a PC-based browser. Several small device client browsers are available which deliver content from the web to the handheld devices.

However, these small devices typically lack the screen space or navigation capabilities to display web content intended for display on a desktop or laptop computer. For example, handheld devices may have displays that are small in size compared with desktop computer displays, and thus, portions of Web content, such as images and text that are otherwise displayable on a desktop computer display, may not be displayable on a handheld computing device display unless some modifications are made to the images or text. Particularly, for example, a desktop computer display having an array of 1024 pixels by 1280 pixels may be able to display a large 32 bit per pixel color image. In contrast, a hand-held computing device with a display having an array of 160 pixels by 120 pixels and with the ability to display only about 3 bits per pixel may have to ignore much of the image data. As a result, the image may not be displayed properly, if at all, on the handheld device display unless the size of the image is reduced.

A number of techniques are available for client or handheld browsers to utilize to assist the user in navigating the web pages on the small screens. For example, client browsers may alter the layout of web content, change the positioning of images, or simply not display some web content. Also, files that may not be displayed on a handheld device display can typically be transformed into a format that is displayable and conforms to the limitations of the handheld device. Web content modification, such as image and text modification, is referred to as “transcoding”.

In one particular example, small device browsers are often unable to display video content files in the form as intended for display on a desktop or laptop computer. To transcode video files, a web server or client device may receive the video file and lower a resolution or lower a rate at which frames are displayed so as to enable the client device to display content from the video file to a user. The server or device may also convert the video file from one format to another, such as from an MPEG4 video format to a 3GP format (third generation wireless platform).

Because some Web servers can recognize the type of client device requesting a file, files in a proper format for display on a requesting client device can be provided. However, an enormous number of Web content files can reside within a Web site on the Internet. Furthermore, an enormous number of files are typically added every day to various Web sites. Because of the tremendous number of files available at Web sites, it may be somewhat impractical to create, store, and maintain duplicate Web content files that are displayable on selected computing devices. Accordingly, it would be desirable to be able to transcode and transform Web content upon demand, and thereby adapt webpages for display on a device other than an originally intended device.

### SUMMARY

Within embodiments described below, a method of providing information content to a device is provided. The method includes sending information content that includes a reference to a video file to a device and receiving a request to transcode the video file into a format that is displayable on the device. The method also includes transcoding the video file into the format that is displayable on the device, storing the transcoded video file, and sending a notification to the device indicating that the video file has been transcoded and is ready for viewing on the device. The notification has a first link that may be selected to view the transcoded video file and a second link that may be selected to access a video inbox that provides access to transcoded video files that have been requested by a user of the device.

In another embodiment, the method includes sending information content that includes a reference to a video file to a device and receiving a request to transcode the video file into a format that is displayable on the device. Following, the video file is transcoded into the format that is displayable on the device, and a notification is sent to the device indicating that the video file has been transcoded. The method also includes storing the transcoded video file once multiple devices have requested that the video file be transcoded and once a predetermined number of requests to transcode the video file have been received.

In another embodiment, a server is provided that comprises a processor and an interface coupled to the processor. The processor executes software applications stored in memory that include a server browser for receiving information content from an information source that includes a reference to a video file and for transcoding the information content into a format that is displayable on a mobile device. The interface sends a notification to the mobile device indicating that the video file has been transcoded and is ready for viewing on the device. The notification has a first link that may be selected to view the transcoded video file and a second link that may be selected to access a video inbox that provides access to transcoded video files that have been requested by a user of the device.

These and other aspects will become apparent to those of ordinary skill in the art by reading the following detailed description, with reference where appropriate to the accompanying drawings. Further, it should be understood that the embodiments noted herein are not intended to limit the scope of the invention as claimed.

### BRIEF DESCRIPTION OF FIGURES

FIG. 1A is a diagram illustrating an example system for accessing, adapting, and presenting video content to electronic devices.

FIG. 1B is another diagram illustrating an example system for accessing, adapting, and presenting video content to electronic devices.

FIG. 2 is a flowchart depicting example functional steps for a method of processing video content for display on a client device.

FIG. 3A is a block diagram illustrating one example of a server for performing the method depicted in the flowchart of FIG. 2.

FIG. 3B is another block diagram illustrating one example of a server for performing the method depicted in the flowchart of FIG. 2.

FIG. 4 illustrates an example flow diagram that illustrates a sequence of actions performed within the system of FIG. 1.

FIGS. 5-8 illustrate example conceptual screen shots as seen on the client device when executing methods described herein.

FIG. 9 illustrates one example of a system such as that shown in FIG. 1 with multiple servers.

### DETAILED DESCRIPTION

The present application provides a manner of converting information content for display on handheld or mobile devices. Some information content includes video files, which certain devices may lack the decoding software and capability to view. Within embodiments discussed below, video files are adapted to be presented to a user on a handheld device. Once a user selects a video file to view from a webpage, a server will retrieve and convert the video file to a format that is displayable on the handheld device. The server will then notify the user (e.g., via an SMS or push message) that the video conversion is complete, and the SMS or Push message will include a link to allow the user to watch the video. The server may also maintain a “My Videos” page where a user can access or watch all the videos that the user has requested to be converted.

Within other embodiments, if a user browses to a video that another user has already had converted, the user will immediately be able to watch the video, assuming that the handheld device is capable of displaying the converted video. Thus, converted videos will be cached. In addition, converted videos can be exchanged between servers within a system so that a number of servers now have a copy of the transcoded video, if for example, the video has been requested a given number of times.

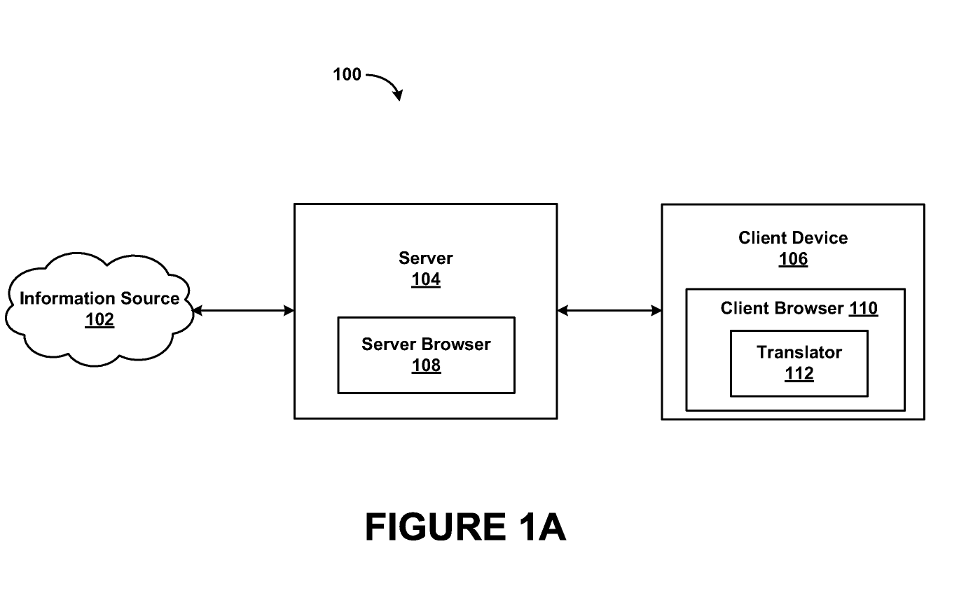

Referring now to FIG. 1A, a high-level diagram is shown illustrating an exemplary system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 provides information content expressed in a markup language, such as those markup languages known in the art including Hypertext Markup Language (HTML), Extensible Markup Language (XML) with or without Extensible Style Sheets (XSL), VoiceXML, Extensible Hypertext Markup Language (XHTML), or Wireless Markup Language (WML). Furthermore, the information content can reference images, video, or audio information to be provided by the information source 102.

The information source 102 can be accessed through any type of network by the server 104 via a server browser 108. The server browser 108 may communicate with the client device over any type of network through a client browser 110. The server browser 108 acts as a proxy between the client browser 110 and the information source 102 of web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102. By utilizing HTTP requests, such as is known in the art, the server browser 108 can access information content, including applications, static and dynamic content, at the information source 102.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. However, it should be understood that the server browser 108 and client browser 110 can be hosted on the same platform such as on an electronic device, especially if the platform or electronic device has the appropriate hardware and network capabilities. Thus, within many embodiments herein, functionality may be described as being part of the client browser 110 or as being part of the server browser 108. It should be understood that the client device 106 and the server 104 may co-exist on the same device, and thus functionality of either can be substituted by each other. Thus, the client browser 110 may perform functions explained as being performed by the server browser 108, and the server browser 108 may perform functions explained as being performed by the client browser 110. By utilizing the server and client browser, smaller electronic devices with limited hardware capability can access feature rich information or data.

Generally, the server 104 and the client device 106 include a central processing unit, a memory (a primary and/or secondary memory unit), an input interface for receiving data, an input interface for receiving input signals from one or more input devices (for example, a keyboard, mouse, etc.), and an output interface for communications with an output device (for example, a monitor). In general, it should be understood that the server 104 and the client device 106 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data. It should also be noted that the server 104 and the client device 106 generally execute application programs resident at the server 104 and the client device 106 under the control of an operating system. The application programs, such as the server browser 108 and the client browser 110, may be stored on memory within the server 104 and the client device 106 and may be provided using machine language instructions or software with object-oriented instructions, such as the Java programming language. However, other programming languages (such as the C++ programming language for instance) could be used as well.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., keyboard, touch screen, mouse, etc.) and an optional display for viewing downloaded information content. Furthermore, the client device 106 can include any type of device that has the capability to utilize speech synthesis markups such as W3C (www.w3.org) Voice Extensible Markup Language (VoiceXML). One skilled in the art of computer systems will understand that the example embodiments are not limited to any particular class or model of computer employed for the client device 106 and will be able to select an appropriate system.

To provide an exemplary illustration, assume that a PDA hosts a client browser 110, a PC hosts the server browser 108, and the PDA and PC are both connected to an Ethernet network. Then, the client browser 110 and the server browser 108 could perform information transactions over the Ethernet network. Such transactions would utilize Ethernet or similarly IEEE 802.3 protocols. Nevertheless, in this example, the client and server browsers communicate over a wired network. The communications might also include a wireless network such as a local area wireless network (LAWN) or wireless local area network (WLAN). Moreover, the communications might include wireless networks that utilize other known protocols and technologies such as Bluetooth, wireless application protocol (WAP), time division multiple access (TDMA), or code division multiple access (CDMA).

Referring again to FIG. 1, the client browser 110 can send a request for information to the server browser 108. The client browser 110 may include an event translator 112 to convert a request/response protocol, such as an HTTP request, from the client browser 110 (e.g., WML, XHTML, cHTML, etc.) to an event that the server browser 108 recognizes. The translation process could include event information, content information, and the context of the event such that transactions between the client browser 110 and the information source 102 (e.g. HTML form submission) are preserved.

Information content from the information source 102 is retrieved and can be tailored for use on the client browser 110 by the server browser 108. Alternatively, the server browser 108 may retrieve the information and send the information to the client browser 110, which itself tailors the information appropriately for viewing. Content transformations may be necessary since the requested content (e.g., a video file) could have been initially designed for viewing on a large screen of a PC, rather than on a limited screen size of a handheld device. As a result, either the server browser 108 or the client browser 110 can perform information content transformations or apply device specific style sheets to aid in presentation (e.g., display or voice) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, QDOM, script executor, normalizer, and serializer, for example. Additional information pertaining to information content transformation or customization is included in U.S. Pat. No. 7,072,984, entitled “System and method for accessing customized information over the internet using a browser for a plurality of electronic devices,” U.S. patent application Ser. No. 10/280,263, entitled “System and Method for Displaying Information Content with Selective Horizontal Scrolling,” U.S. patent application Ser. No. 09/843,036, entitled “System and Method for Adapting Information Content for an Electronic Device,” U.S. patent application Ser. No. 11/526,992, entitled “System and Method for Web Navigation Using Images,” and U.S. patent application Ser. No. ______, (Attorney docket no. 07-107-A), entitled “Method and System for Converting Interactive Animated Information Content for Display on Mobile Devices,” the contents of each of which are incorporated herein by reference as if fully set forth in this description.

Many different content transformations can occur based on the information present within a requested web page. For example, video files may be included within web page content and will be transformed for viewing on the client device.

The system 100 includes software (within the client browser 110 or the server browser 108) for transcoding or converting video files into a format for display on the client device 106. As used herein, a video file may be a collection of frames of content for viewing in a sequential display, for example, to provide for animation on a screen. The video file may be in many formats, such as those known in the art like a Flash FLV file, wmv file, real file, MPEG, etc.

The server 104 in the system 100 may transcode both webpage content and video file content. Alternatively, additional servers may be implemented to transcode the video file content. FIG. 1B illustrates an alternate configuration of the system in which the server 104 operates to transcode web page content, and video transcoding servers 114 are used to transcode video file content. A video database 116 may also be included to store transcoded video files.

Modifying digital video from a digital video stream having one characteristic to a video stream having a different characteristic is referred to generally as video transcoding, and the video file may be transcoded into a format for display on the client device 106 using many different techniques. Examples of different characteristics include video encoding format (e.g. MPEG1 and MPEG2) and data rates, such as affected by different quantization values. When all the video information of one video stream is maintained during a transcoding, a video stream lossless transcoding is said to occur. For Lossless transcoding to occur, it may be necessary that that the bandwidth available to the second video stream is sufficient to support the data present in the original video stream. In one example, lossless video transcoding between video encoding formats can be accomplished by decoding a first video stream having a first video encoding format to generate rendered data (image data), followed by encoding the rendered data to generate a second video data stream having a second video encoding format.

Other examples of transcoding include a typical video file in an MPEG2 format being transformed for viewing on the client device 106 by lowering the resolution of the video or lowering a frames per second display rate, by removing some of the frames. Specifically, the MPEG2 stream that was broadcast for television receivers can be transformed to a low-resolution stream, such as an MPEG4 stream. A transcoder can receive the MPEG2 stream and decompress compressed video data contained in the MPEG2 stream. The transcoder can then convert the received video data to, for example, a resolution of 360 pixels times 240 lines and to 10 frames/second for the mobile client device, for example.

In addition, transcoding may include changing the video size from one size to another (also referred to as scaling). This typically involves taking a larger video and scaling the video down to a smaller size to reduce an amount of bandwidth required to send the video to the client, and to ensure that the client is able to display the resulting video. Since many clients fail when receiving a video size that is too large, sending a video that is too large may result in entirely wasted bandwidth. Thus, determining a correct scaling factor for each mobile device can be useful.

Other transcoding techniques involve compression of the video files. Most video files use some type of compression to reduce the size. A full size video in its raw format would be too large for many devices. Hence “codecs” or types of compression algorithms are used to reduce the size of the video into a file format that can be decoded later. However when such a process is performed, quality can be degraded and some codecs are even “lossy” to reduce the amount of data needed to display the video. This is usually performed by digitizing a first frame of a video into data known as an I-frame and then comparing the first frame to a next frame. Only the differences between the two frames are recorded into a P-frame. In this manner, not all the frames have to be digitized, but only the differences between the frames, which results in less data being used to store the video. Other I-frames may also be sent at some interval to allow recovery from any data corruption that may have occurred during transmission.

Since many different codecs or types of compression exist for video (both for the visual and audible components of the video file), it can be advantageous to know which clients support certain codecs. Detecting which clients support which formats allows for selecting a best possible video quality to be sent to a specific client. For example, AMR-NB (Narrow Band) is a type of audio codec that is optimized to be small in size and good for human voices, however, the codec may not be good quality for music. MP4 Audio, however, is a format that is larger and supported on fewer clients but has been found to be acceptable for music and multimedia.

The transcoded video may be streamed to the client. Streaming allows the video to start playing immediately without requiring the entire video file to be downloaded. Streaming also allows the client to free up memory used by already viewed portions of the video. Streaming requires splitting up the video file into small packets that could be sent to a client one by one. The process of splitting the video file into packets is called “hinting”, which includes preparing the packets to be split and informing a streaming server how to send the split packets to the client. Many streaming servers require a video file to be hinted prior to streaming the video to clients. A video file that is not hinted may fail to be streamed and a client would therefore receive an error.

In an exemplary embodiment, when a user encounters a webpage with video content, the user can select to view the video content and wait for the server to transcode the video file and to stream the transcoded video file to the user's client device. Alternatively, the user may request that the server transcode the video file and to send the transcoded video file to the user's device, where the transcoded video file will be stored. While waiting for the video to be transcoded, the user may browse other websites, for example. The user may then view the video file at a later time that is convenient by accessing a video file “inbox.” Still, as another alternative, the transcoded video file could be stored at the server or at another database, and the server can send a notification to the user's device to indicate that the video file has been transcoded. The user can then access a video file inbox and request that the transcoded video file be sent to the user's mobile device. By having the video file transcoded and stored in the transcoded form, the user can select a time to view the transcoded video file without having to wait for the video to be converted.

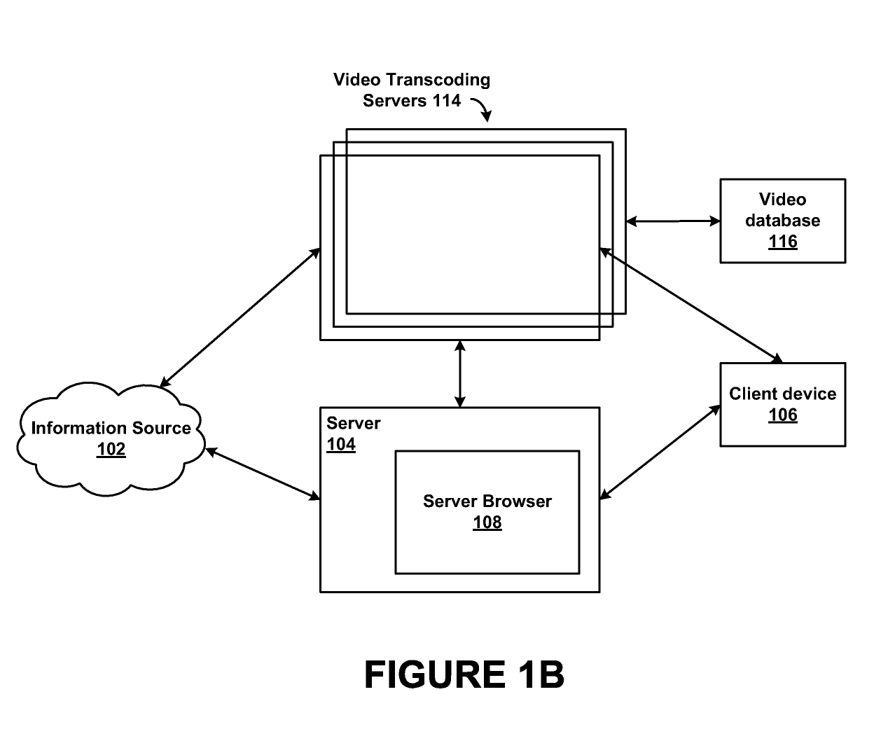

FIG. 2 is a flowchart depicting functional steps for a method 200 of processing information content for display on a client device. It should be understood that each block in this flowchart (and within other flow diagrams presented herein) may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

First, the client browser 110 will send a request for information content to the server browser 108, which contacts the information source 102 to obtain the information content. The server browser 108 will then receive the information content from the information source 102, as shown at block 202. The information content may be a typical web page (e.g., HTML document) including text and images associated therewith. The information content also may include a video file.

After receiving the requested information content including the video file, the server will load the webpage and identify content that includes video, as shown at block 204. The server may identify video content within a webpage by filtering through all attachments or links to the webpage, and noting a type of file associated with the link. For areas of the webpage that include video content, the server may generate a reference to the video content in the webpage, as shown at block 206. For example, the server will retrieve or generate a snapshot of the video, such as a still image of a first frame of the video, to present to the user. The server will also adapt the webpage for viewing on the handheld device and send the webpage with the reference to the video content to the client device, as shown at block 208. The server may also include a link selectable by the user of the client device to instruct the server to transcode the video file into a format that may be displayed on the client device.

Upon selection of the link to instruct the server to convert the video file, the server will receive the request, as shown at block 210, and transcode the video file. Videos will be converted based on the capabilities of the client device or capabilities of the client browser. The server will then notify the user that the video conversion is complete, as shown at block 212. The server may notify the user in any number of ways, such as for example, using a Short Message Service (SMS) or Push messaging that includes link to allow the user to watch the video. Thus, the notification may be text messages such as those provided according to the well-known short message service (SMS) protocol, as defined in IS-41 and in Interim Standard 647-A (IS-647-A), as published by the Telecommunication Industry Association, which are both herein incorporated by reference. However, the notification message may be in any form, such as a voice message, a graphical icon message, or any combination of text, graphics, and voice.

The notification message includes an identifier, which links to the associated transcoded video file. The server may place a video file identifier into the notification prior to the server sending the notification message to client device. The client device, in turn, may send the identifier to the server to retrieve the associated transcoded video file. In this manner, the server may send a link to a page, such as a “My Videos” page, where a user can access all the videos that the user has requested to be converted (and that have not expired from the cache).

Once the server has transcoded the video file once for the user, if the user were to browse back to the previous webpage including the same video file, instead of being given the option to convert the video file, the server will provide the user with the option to watch the video because the server will have access to the stored transcoded video file (for a desired amount of time). The converted videos will be cached and the amount of time that the converted files are cached will be configurable.

Because the server may store a transcoded form of the video file, if a second user were to browse to the original video and desire to view the video, the second user may immediately be able to view the transcoded video (or otherwise have access to the transcoded video, assuming that the second user's mobile device is capable of displaying the transcoded video) because the server has already performed the conversion. In this manner, the server stores transcoded video files for a limited amount of time, and if a second user were to request one of the video files that had been transcoded during this time, then the server may simply retrieve the stored transcoded video file and provide the transcoded video file to the second user. Short term storage of transcoded video files allows users to view the videos without having to wait for the server to perform the conversion, and allows the server to only store video files that have been recently transcoded so that a large memory bank is not necessary. Using exemplary embodiments, videos will be readily available for other users in a transcoded form because the server preserves the transcoded form of the video file for a desired amount of time.

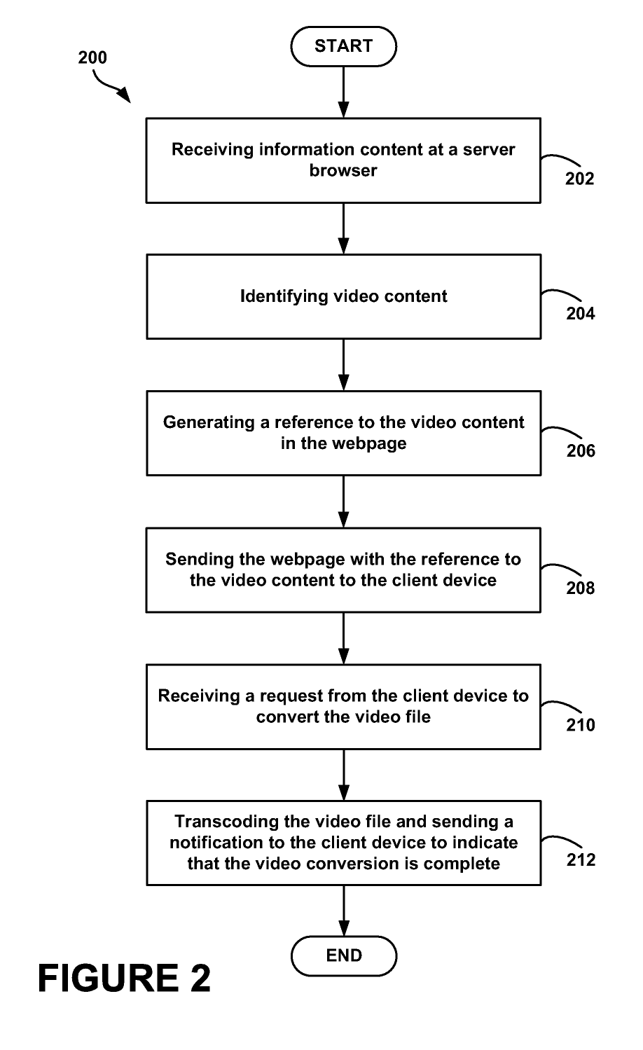

FIG. 3A is a block diagram illustrating one example of a server 300 for performing the method depicted in the flowchart of FIG. 2. The server 300 includes an input interface 302 coupled to a processor 304 and a server browser 306. The server browser 306 may be stored in memory (not shown) so that the processor 304 accesses the memory to execute software or program instructions that enable operation of the server browser 306. The server browser 306 includes components such as a TCP/IP engine 308. The server also includes a video streamer 310 with a video file converter 312 that may be executed through additional software or program instructions by the processor, for example. Alternatively, the video streamer 310 and video file converter 312 may be implemented within portions of the processor 304 as well. The video streamer 310 and video file converter 312 may also reside on a computer separate from the server 300, and when the streamer and converter are separated, the streamer and converter may be referred to as a video transcoding server (as illustrated in FIG. 3B, video transcoding server 316). A single server 300 may request video transcoding from many video transcoding servers. A video database 314 will store the transcoded videos. In the instance in which the video streamer 310 and video file converter 312 reside on a computer separate from the server 300, the server 300 may perform transcoding of web page content, while the video transcoding server 316 performs transcoding of video file content.

The server browser 306 is a software application that is executable by the processor 304 to read an electronic document or electronic data, and render the data into a visual display of text and/or graphics for display. The server browser 306 may include such operating functional components as windows, pull-down menus, buttons, and scroll bars, and thus may be a typical web browser.

The server 300 will receive requests for information from client devices, and will responsively access the information source to retrieve the information. The server 300 will then be operated by the processor 304 to convert the information into a form accessible by the requesting client device. For example, a client device may request a typical web page, and thus the server 300 will access the Internet and retrieve the requested web page and then the processor 304 can convert the web page into a form accessible by the client device. In some instances, the web page will include a movie or video file, and thus the server 300 will retrieve and load the web page on the server browser 306. The processor 304 can then capture a static image of the movie and insert the captured image into the webpage during conversion of the webpage to a format displayable by the client device. The processor 304 can further access the video file converter 312 to transcode the video file into a format that may be displayed and viewed on the client device. The video file converter 312 will write transcoded videos to the database 314 and the video streamer 310 will read videos from the database 314 when the videos are available. The video streamer 310 will then send the actual video content to the client.

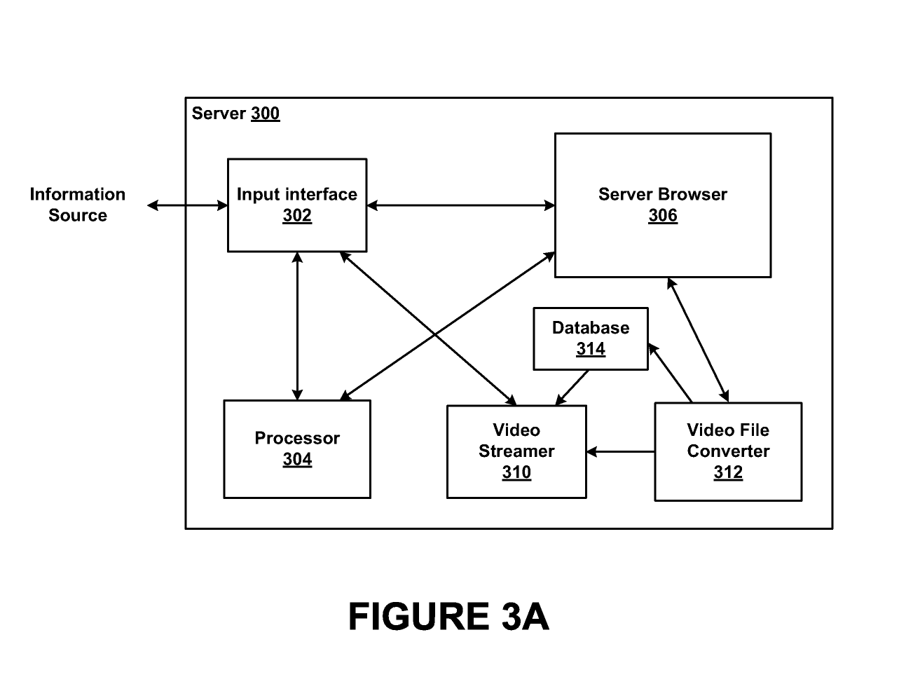

FIG. 4 illustrates an example flow diagram that illustrates a sequence of actions performed within the system of FIG. 1 according to the present application. Initially, as shown, the client device 106 will request an HTML webpage. The client device 106 will send the request to the server 104, and the server 104 will retrieve the HTML webpage from the information source 102. The server 104 will receive the HTML webpage from the information source 102 and will transcode the webpage and tailor the webpage for viewing on the client device 106. The server 104 then sends the transformed webpage to the client device 106. In the instance in which the webpage includes a video file or a link to a video file, the server 104 may simply insert a static image from the video file into the webpage content. The client device 106 may then request the video file content from the server 104. The server 104 will retrieve the video file content from the information source 102. The server 104 can then transcode the video file, and respond to the client device 106 with a notification indicating that the video file has been transcoded and is ready for viewing on the device. The notification may include a link that may be selected to view the transcoded video file and/or a second link that may be selected to access a video inbox that provides access to transcoded video files that have been requested by a user of the device.

The server may be connected to a short message service center (SMSC), which sends the notification to the client device in the form of an SMS message. An SMSC may function as a store-and-forward system for messages. The system 100 provides the mechanisms required to find a destination client device, such that an SMSC may then transport messages to the destination client device. The SMSC may forward the SMS message to the client device using an SMS delivery point-to-point (SMSDPP) format (e.g., accomplished via the use of “forwardShortMessage” mechanisms as defined in IS-41). However, if the client device is inaccessible at any time during which the SMSC is attempting to deliver a message, the SMSC may then store the message until a later time when the MS becomes accessible. Several mechanisms are available to send notification messages to the client devices through an SMSC. For example, paging networks, specialized software for personnel computer based messaging, and operator bureaus can initiate a notification message.

Alternatively, the server 104 may function as an external short message entity (ESME) as defined in IS-41. The server 104 may generate notification messages indicating that the video file has been transcoded and send the generated messages via a circuit or packet switched network the client device. The notification messages may be text messages such as those provided according to the well-known short message service (SMS) protocol, as defined in IS-41 and in Interim Standard 647-A (IS-647-A), as published by the Telecommunication Industry Association, which are both herein incorporated by reference. However, the notification messages may be in any form, such as a voice message, a graphical icon message, or any combination of text, graphics, and voice.

The notification messages also preferably include identifiers, which link to their associated transcoded video file. For example, the server 104 may place a video file identifier into the notification message prior to the server 104 sending the message to client device. The client device may send the identifier to the server 104 in order to retrieve the associated transcoded video file.

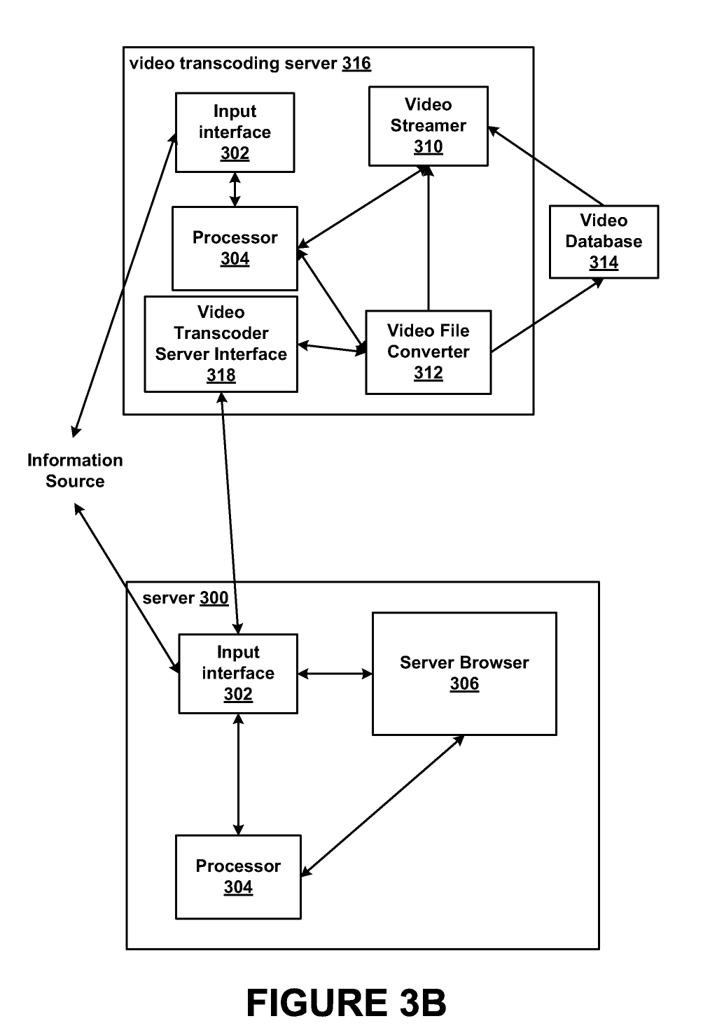

FIGS. 5-8 illustrate conceptual screen shots as seen on the client device when executing methods described herein. For example, FIG. 5 illustrates a conceptual transcoded webpage being viewed on a handheld device. The webpage, in this example, includes a thumbnail image representing a video file and links that may be selected to either watch the video or convert the video into a format displayable on the handheld device. If the user clicks “Watch Video”, then a native video player will be launched to play the video. The server will stream the video to the client device in real time and convert or transcode the video while doing so. The video may take some time to load on the device, due to delays at the server for converting the video in a format displayable on the client device.

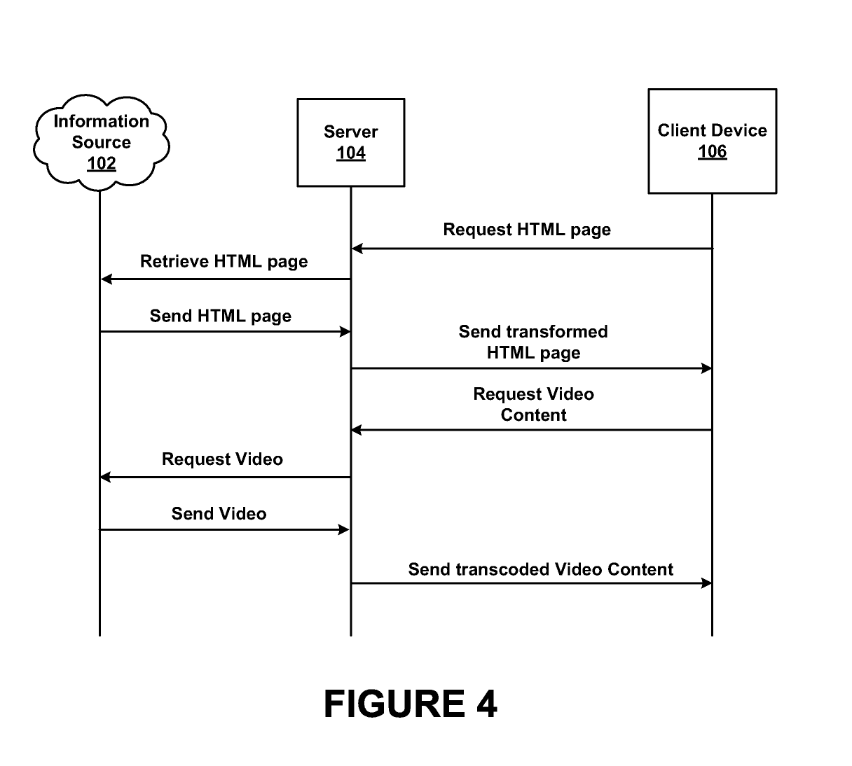

If the user would rather browse other pages or perform other tasks while the server performs the conversion of the video file, the user may click “Convert Video”, as shown in FIG. 6. The server would then begin transcoding the video file, and a message such as that shown in FIG. 6 could be displayed on the client device indicating that the conversion is in progress and the user will be notified when the conversion is complete. The user of the client device may then browse to other webpages while waiting, for example.

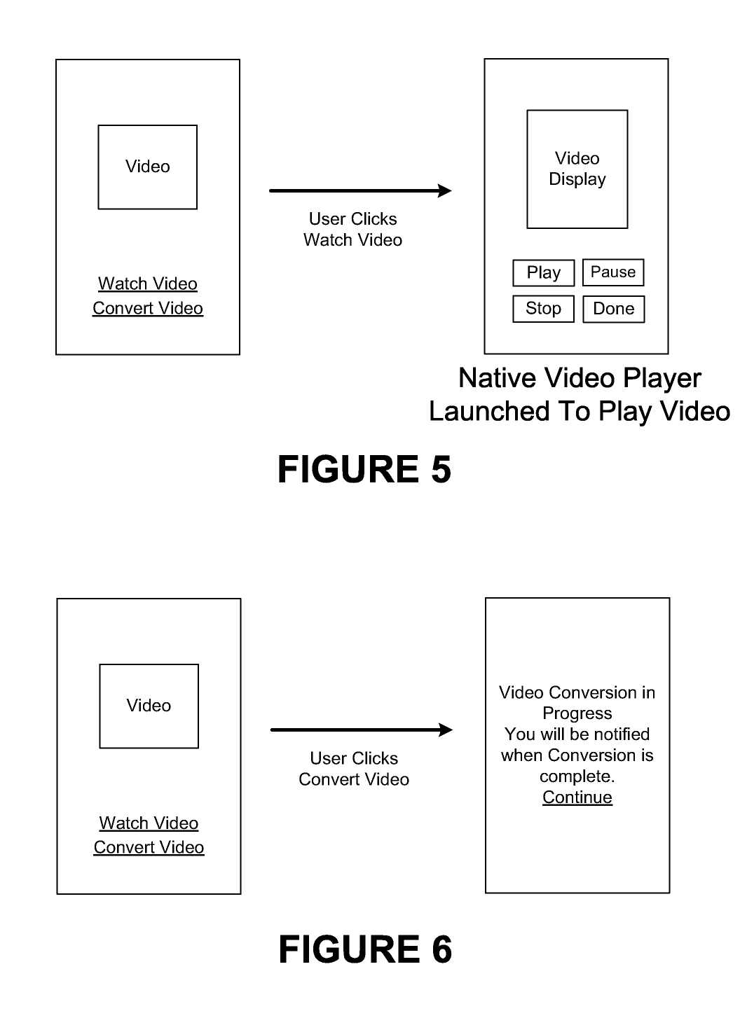

Once the server has completed conversion of the video file, the server will send a notification to the client device. The notification will indicate that the video file has been transcoded and is ready for viewing on the client device, as shown in FIG. 7. The notification will also include a link that may be selected to view the transcoded video file (“Watch Video Now”), and a second link (“My Videos”) that may be selected to access a video inbox that provides access to transcoded video files that have been requested by a user of the device. FIG. 7 illustrates that when the user selects the “Watch Video Now” link, the server will stream the transcoded video to the client device, which will launch a video player to display the video.

The client device includes applications to display the notification messages. For instance, a typical SMS text viewer that displays short text messages, possibly by abbreviating words or sentences, may display the notification messages within the client device. Additionally, the client browser may be able to display the notification messages. Still other graphical user interfaces or textual user interfaces may be employed.

The client device may receive notification messages from the server and display the messages in a list (or other equivalent grouping) to a user of the client device, using an application, such as the client browser. When the client device receives a notification message, the client browser may responsively open to display all messages that the user of the client device has previously and/or currently received. Alternatively, the user may request the client browser to open and after the browser opens, the user may then scroll up or down the list of notification messages and select a message associated with a transcoded video file that the user desires to view.

The notification messages may include (as text or encoded) several parameters or information of the transcoded video file. For example, the notification message may include the video file's name, length, request date, or other characteristics of the video file or website from which the video file was requested.

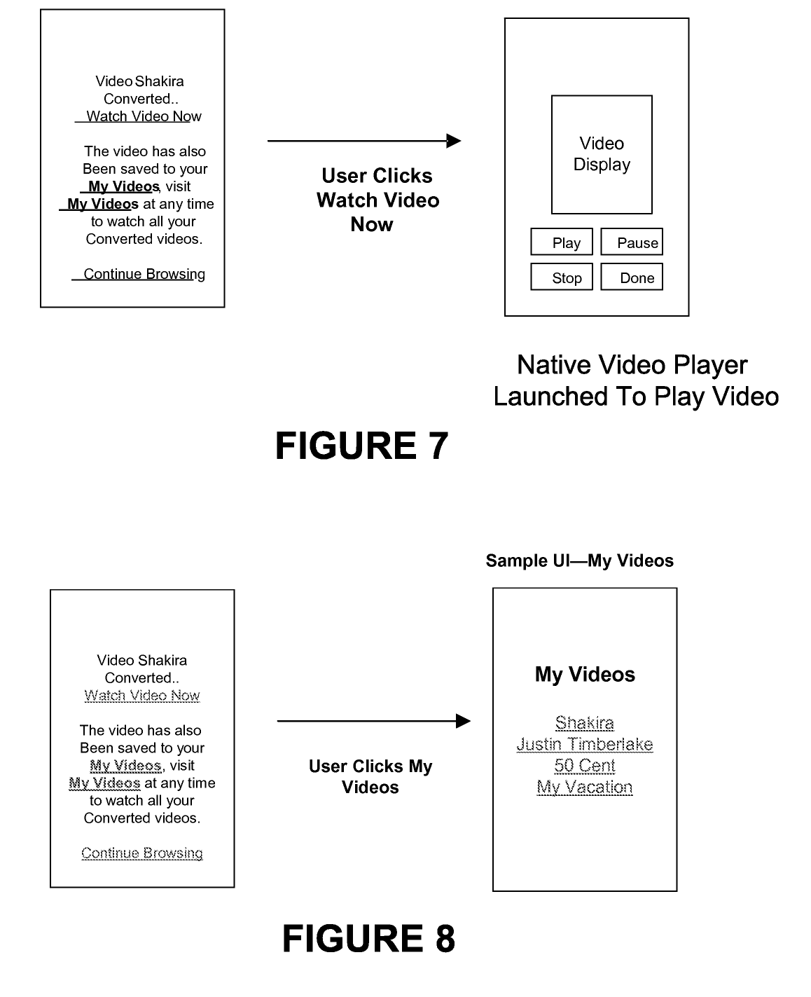

FIG. 8 illustrates that when the user selects the “My Videos” link, the server will connect the client device to the user's Video inbox, which includes links to the currently requested transcoded video file and all other previously requested transcoded video files that are still being stored. The user may then select a specific link to view any of the video files. The server may store the transcoded videos files for the user for a limited amount of time, so that the user will have access to requested video files only for this time. The server may remove a transcoded video file from storage, for example, after a week, so that if a user returns to the user's Video inbox a week later the user will no longer have access to the transcoded video file. Access to transcoded video files would be added and removed from the user's Video inbox on a rolling basis.

Once a user selects a link within a notification message, the client device extracts the identifier from the message and sends the identifier to the server to request the stored transcoded video file. The server will then stream the transcoded video file to the client device using known techniques.

Using the embodiments discussed above, a user can request that a video file be transcoded for viewing on a client device and then return at a later time to the client device to retrieve the transcoded video file. Instead of waiting for the video file to be converted, the user could retrieve a transcoded version of the video file at a later time that was convenient. The transcoded video file would then be available for a limited amount of time within the user's Video inbox.

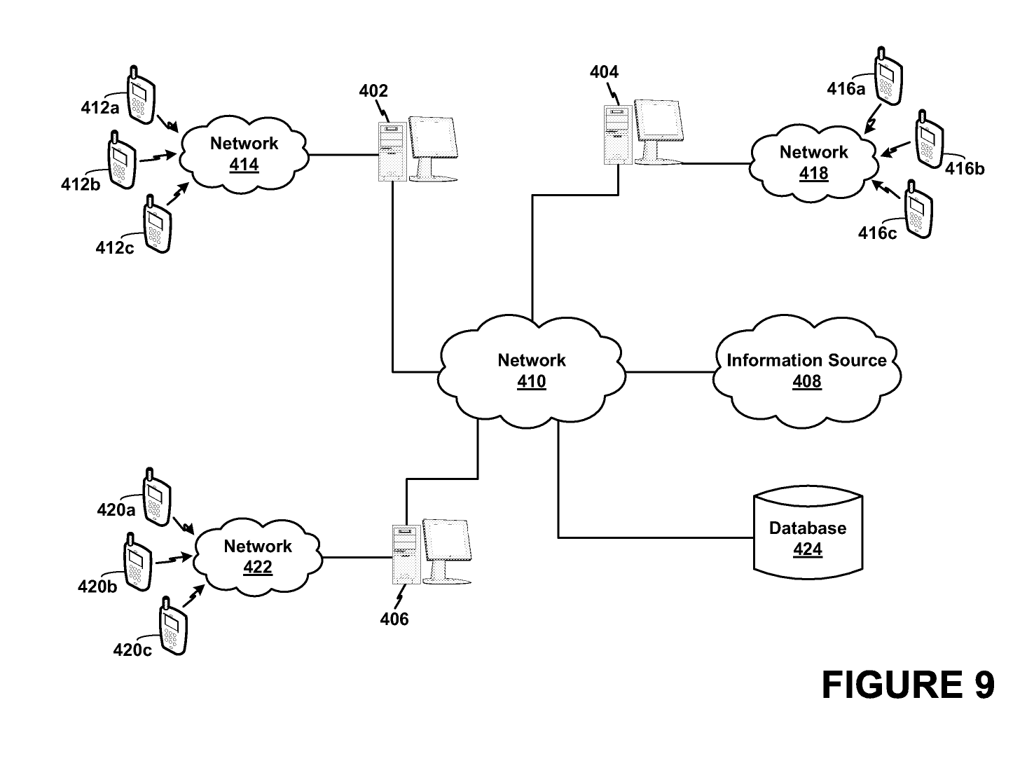

The methods above have been described with reference to a single server and client device system. However, the system may include many servers each of which communicates with many client devices at any given time. FIG. 9 illustrates one embodiment of a system with multiple servers, for example. The system includes servers 402, 404 and 406 each of which is connected to an information source 408 via a network 410. Many client devices communicate with each server individually. For example, client devices 412a-c communicate with server 402a through network 414, client devices 416a-c communicate with server 404a through network 418 and client devices 420a-c communicate with server 406a through network 422.

The networks 414, 418 and 422 may be wireless networks, such as a CDMA network, or wired networks like an Ethernet network. Further, although networks 414, 418 and 422 are shown to be separate networks, the networks 414, 418 and 422 may be the same network or a subset of the same network, so that all client devices 412a-c, 416a-c and 420a-c and servers 402, 404 and 406 communicate over the same network. In this regard, network 410 may be a wired or wireless network and may also be the same network as the networks 414, 418 and 422. Thus, each server and client device cluster may communicate over the same network, for example.

Methods of the present application can be used within the system of FIG. 9 to optimize resources, and lessen wait times for client devices to receive requested information content. It would be desirable for servers within the system of FIG. 9 to only have to transcode video file content one time. As such, in one embodiment, the system in FIG. 9 includes a database 424 to store transcoded video files and each of the servers 402, 404 and 406 may store and retrieve transcoded video files in the database 424 via the network 410.

With the centralized database 424 present in the system, many techniques may be implemented to optimize processing power of the servers. For example, suppose over a short period of time, many client devices request the same video file from the information source 408, and thus each of the servers would have to transcode the same video file multiple times to send transcoded video files to the client devices. The servers can alternatively access the database 424 to see if the video file has already been transcoded and stored, and then simply retrieve the transcoded file and send the transcoded file to the requesting client device.

A server may store every video file that the server transcodes in the database 424, or the server may only store certain transcoded files. For example, the servers may only store transcoded video files once a certain number of requests have been received for the video file so that if the video becomes popular enough (requested e.g., 100 times), then a copy of the transcoded video file can be saved in the database 424. All of the servers would then have access the transcoded video file.

The database 424 may store transcoded video files for a limited amount of time. For example, the database 424 may store videos for about a week, and may remove videos on a first in first out basis.

As another alternative, if one server within the cluster of servers in FIG. 9 were to receive a large number of requests to transcode a certain video file, the server could send a copy of the resulting transcoded video file to all the other servers in the cluster so that each would have a copy on hand and ready to be sent to a requesting client device. In this manner, a client device would have a lower wait time to receive popular video files.

It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

In view of the wide variety of embodiments to which the principles of the present application can be applied, it should be understood that the illustrated embodiments are exemplary only, and should not be taken as limiting the scope of the present application. For example, the steps of the flow diagrams may be taken in sequences other than those described, and more or fewer elements may be used in the block diagrams. While various elements of embodiments have been described as being implemented in software, in other embodiments in hardware or firmware implementations may alternatively be used, and vice-versa.

Note that while the present application has been described in the context of a fully functional server and client device system and method, those skilled in the art will appreciate that mechanisms of the present application are capable of being distributed in the form of a computer-readable medium of instructions in a variety of forms, and that the present application applies equally regardless of the particular type of signal bearing media used to actually carry out the distribution. For example, a computer usable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals. As such, the methods described herein may be embodied in a computer program product that includes one or more computer readable media, as described as being present within the server 104 or the client device 110.

The claims should not be read as limited to the described order or elements unless stated to that effect. Therefore, all embodiments that come within the scope and spirit of the following claims and equivalents thereto are claimed as the invention.

What is claimed is:

1. A method of providing information content to a device comprising:
sending information content that includes a reference to a video file to a device;
receiving a request to transcode the video file into a format that is displayable on the device;
transcoding the video file into the format that is displayable on the device;
storing the transcoded video file; and
sending a notification to the device indicating that the video file has been transcoded and is ready for viewing on the device, the notification having a first link that may be selected to view the transcoded video file and a second link that may be selected to access a video inbox that provides access to transcoded video files that have been requested by a user of the device.

2. The method of claim 1, wherein the device is a mobile handheld device.

3. The method of claim 1, wherein storing the transcoded video file comprises storing the transcoded video file for a limited amount of time.

4. The method of claim 3, further comprising:
sending the information content that includes the reference to the video file to a second device;
receiving a request to transcode the video file into a format that is displayable on the second device;
searching stored transcoded video files to determine if the requested video file has already been transcoded; and
if so, providing access to the stored transcoded video file to the second device.

5. The method of claim 4, wherein providing access to the stored transcoded video file to the second device comprises sending a copy of the transcoded video file to the second device.

6. The method of claim 1, wherein the first link may be selected to request that the transcoded video file be streamed to the device.

7. The method of claim 1, wherein storing the transcoded video file comprises storing the transcoded video file in a database linked to the video inbox of the user of the device.

8. The method of claim 7, further comprising storing the transcoded video file in the database for a limited amount of time.

9. The method of claim 1, wherein sending the notification to the device comprises sending a Short Message Service (SMS) message.

10. A computer readable medium having stored thereon instructions for causing a processing unit to execute the method of claim 1.

11. A method of providing information content to a device comprising:
sending information content that includes a reference to a video file to a device;
receiving a request to transcode the video file into a format that is displayable on the device;
transcoding the video file into the format that is displayable on the device;
sending a notification to the device indicating that the video file has been transcoded; and
storing the transcoded video file once multiple devices have requested that the video file be transcoded and once a predetermined number of requests to transcode the video file have been received.

12. The method of claim 11, wherein the method is performed by a server and wherein storing the transcoded video file comprises storing the transcoded video file in a database that is accessible by multiple servers.

13. The method of claim 11, wherein the method is performed by a server and wherein storing the transcoded video file comprises storing the transcoded video file at the server.

14. The method of claim 11, wherein the method is performed by a server that is present within a system with multiple servers, and wherein the method further includes the server sending the transcoded video file to the other multiple servers.

15. The method of claim 11, wherein the method is performed by a server that is present within a system with multiple servers, and wherein the method further comprises:
determining a number of requests received at each of the multiple servers to transcode the video file; and
determining if the video file has been requested the predetermined number of times.

16. The method of claim 11, wherein sending the notification to the device indicating that the video file has been transcoded comprises sending a notification including a first link that may be selected to view the transcoded video file and a second link that may be selected to access a video inbox that provides access to transcoded video files that have been requested by a user of the device.

17. A server comprising:
a processor for executing software applications stored in memory, the software applications including a server browser for (i) receiving information content from an information source, wherein the information content includes a reference to a video file, and for (ii) transcoding the video file into a format that is displayable on a mobile device; and
an interface coupled to the processor for sending a notification to the mobile device indicating that the video file has been transcoded and is ready for viewing on the device, the notification having a first link that may be selected to view the transcoded video file and a second link that may be selected to access a video inbox that provides access to transcoded video files that have been requested by a user of the device.
